(19) United States
(12) Patent Application Publication
(10) Pub. No.: US 2003/0077210 A1
(43) Pub. Date: Apr. 24, 2003

(54) Atomizing nozzle

(76) Inventors: Michael Nau, Dornhan/Aischfeld (DE); Manfred Ruoff, Moeglingen (DE); Marc Bareis, Markgroeningen (DE); Frank Ilgner, Karlsruhe (DE); Horst Harndorf, Schwieberdingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,479

(22) PCT Filed: Jan. 17, 2001
(86) PCT No.: PCT/DE01/00163

(51) Int. Cl. B01J 10/00; C01B 3/00

(52) U.S. Cl. 422/194; 118/61

(57) ABSTRACT

The invention relates to atomizing apparatus for a gas/fluid mixture, in particular for introduction into a chemical reformer for generating hydrogen, which contains at least one gas supply line (10, 10′) for supplying a gas flow (11, 11′) and at least one fluid supply line for supplying a fluid flow. The gas supply line (10, 10′) has at least one first branch point (14, 14′) at which a partial flow (21, 21′) of the gas flow (11, 11′) can be split off into a side line (20, 20′), which is embodied as a bypass. The fluid flow feeds into the side line (20, 20′) at an outlet point (26) of the fluid supply line. The gas supply line (10, 10′) has at least one second branch point (16) at which the side line (20) with the partial flow (21, 21′) containing the fluid flow can be reintroduced.

The invention relates to an atomizing apparatus, in particular for introducing a gas/fluid mixture into a chemical reformer as generically defined by the preamble to claim 1.

### PRIOR ART

Among the alternative drive concepts for motor vehicles, increased attention is currently being focused primarily on fuel cell-supported systems. These systems customarily contain PEM fuel cells (PEM: Polymer Electrolyte Membrane), which are driven using hydrogen and air as energy sources.

Since the refueling and storage of hydrogen in the motor vehicle is still problematic, the hydrogen is produced “on board” as needed from readily available fuels such as methanol, methane, diesel, or gasoline in a preceding reformer stage and is consumed immediately. The reformers used for this are chemical reactors, which are used to partially oxidize the fuels, through the addition of air and moisture, for example at 800° C. in heated catalytic converters, to produce hydrogen and other descendants such as CO and CO₂.

In this connection, the charging of the reformer with the educts required for the reaction is of great importance. Customarily, all of the educts, such as air, water, and fuel are supplied to the reformer in a gaseous state. This requires a pre-atomizer, which is capable of supplying the appropriate quantities of gaseous fuel and water vapor.

During the cold starting phase, however, problems arise because the fluid educts cannot be atomized by the waste heat of the reformer, but only by means of an electrically heated atomizer. Also when there are abruptly changing load alternation demands, conventional atomizers are incapable of instantaneously generating the appropriate quantities of gaseous reactands.

Alternatively, designs have therefore been developed to inject fuels and water directly into the reformer in fluid form. However, in order to assure the most optimal possible reaction behavior in the reformer, the fluid educts must be furnished to the reformer in a finely dispersed form. U.S. Pat. No. 3,971,847 describes a reactor for producing hydrogen, which contains a nozzle that is used to inject fluid hydrocarbons into an airflow. The mist produced is swirled by baffles before it arrives in the actual reaction zone. The water required for the reaction, however, is atomized separately in a pre-atomizer.

The object to be attained is comprised in providing an atomizing apparatus for simultaneously atomizing water and fluid fuels, where the atomizing apparatus should assure a very high degree of atomization and mixture of the educts and moreover an instantaneous metered addition of the fluid educts.

### ADVANTAGES OF THE INVENTION

The atomizing apparatus according to the invention and the method with the characterizing features of claim 1, has the advantage that a gas/fluid mixture is produced, which is distinguished by means of a high degree of atomization and a favorably thorough mixture of the reactands. Moreover, a favorable cold starting behavior of the system and an adequate capacity to react to dynamic load alternation are assured.

The high degree of atomization is achieved by virtue of the fact that the gas flow into which the fluid to be atomized is to be introduced is divided into a main gas flow and a partial gas flow, the partial gas flow feeds into a premixing chamber into which the fluid to be atomized is injected and the gas/fluid mixture thus produced is reintroduced into the main gas flow and homogeneously mixed with it. It is particularly advantageous that the throttle losses can be minimized inside the atomizing apparatus since only a small part of the overall gas flow takes the path that is unfavorable from a technical flow standpoint via the premixing chamber and in spite of this, a favorable atomization and mixing of the fluid components takes place.

Due to the purely gas-supported atomization of fluids, only low fluid pressures are required and the installation of expensive high-pressure pumps can be eliminated.

Advantageous modifications and improvements of the atomizing apparatus disclosed in the independent claims are possible by means of the measures taken in the dependent claims.

Thus, it is particularly advantageous if the fluid components can also be supplied to the reformer as needed in a gaseous form. This is assured by means of a premixing chamber that can be heated. It is also advantageous if as effective as possible a mixing of the partial gas flow and the main gas flow takes place at the junction point at which the fluid-laden partial gas flow is reintroduced into the main gas flow. This is achieved by virtue of the fact that in the vicinity of the junction point, the main gas line has a cross sectional reduction, preferably in the form of a venturi tube.

In another advantageous embodiment, two separate gas supply lines for water vapor and air are provided, each of which has a respective branch for a main gas flow and a partial gas flow. Both partial gas flows are supplied to the premixing chamber. This arrangement permits a favorable preadjustment of the mixture produced in the premixing chamber.

### DRAWINGS

An exemplary embodiment of the invention is shown in the drawings and will be explained in detail in the subsequent description.

FIG. 1 shows a schematic representation of a first exemplary embodiment of the atomizing apparatus according to the invention and

FIG. 2 shows a schematic representation of an additional exemplary embodiment.

### EXEMPLARY EMBODIMENTS

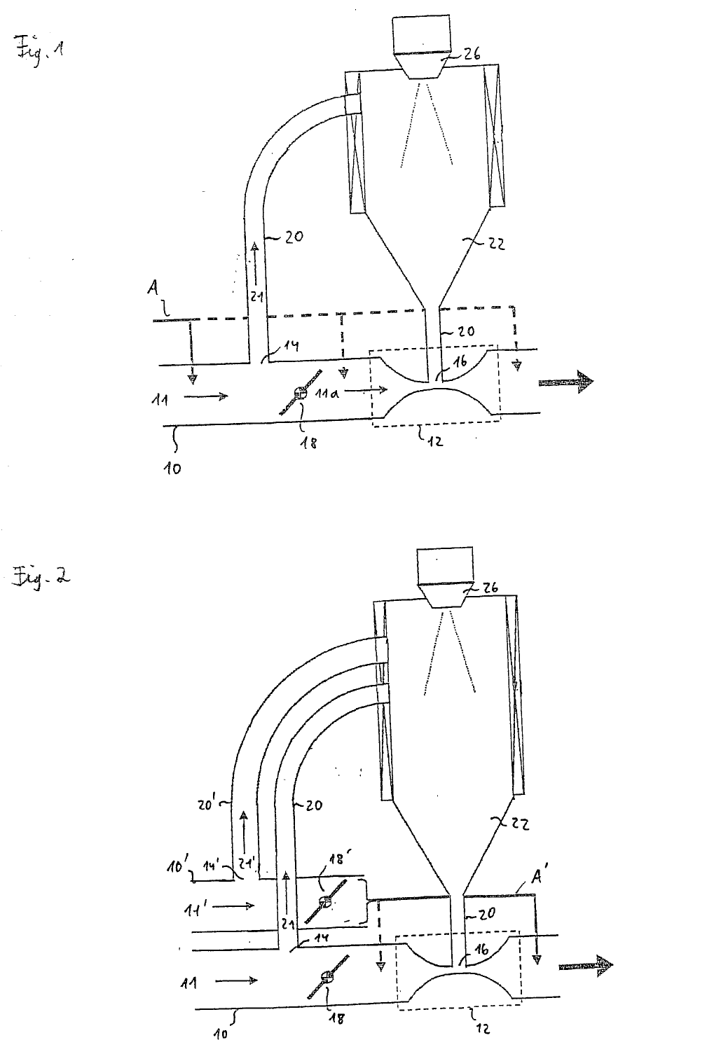

The atomizing apparatus shown in FIG. 1 contains a gas supply line 10, which a gas flow 11 passes through, and a region 12, which has a reduced flow cross section and is preferably embodied as a venturi tube. The gas supply line also has a first and second branch point 14, 16. At the first branch point 14, a side line 20 splits off, which is embodied as a bypass and conveys a partial flow 21 of the gas flow 11 to a premixing chamber 22. The side line 20 continues at the outlet end of the premixing chamber 22 and feeds back into the gas supply line 10 at the second branch point 16. The branch point 16 is disposed in the vicinity 12 of the gas supply line 10 that is preferably embodied as a venturi tube. A position in the vicinity of the smallest flow cross section of the venturi tube, which is also referred to as the throat cross section, is particularly advantageous.

An outlet opening 26 in the form of an atomizing nozzle is integrated into the premixing chamber 22, which homogeneously mixes the fluid educts such as water and/or fuel that are supplied via a fluid supply line with the gaseous educts that constitute the partial flow 21. Nozzles known to the profession such as perforated flow nozzles and screen flow valves, among others, can be used for the atomizing nozzle.

In order to assure a favorable premixing, the premixing chamber 22 also contains, for example, an annular conduit, which is integrated into the chamber wall and into which the partial gas flow 21 feeds. Alternatively, the partial flow 21 can also be supplied tangentially to the premixing chamber 22. Between the first branch point 14 and the section of the cross sectional reduction 12, the gas supply line 10 has a means for regulating the gas volume flow, preferably a throttle valve 18. It controls the proportional division of the gas flow 11 into a remainder gas flow 11a and the partial gas flow 21. For technical flow reasons, as low as possible a proportion of the partial gas flow 21 to the main gas flow 11 is desirable.

The gas flow 11 is essentially composed of the gaseous educts of the reformer and primarily contains air, water vapor, or also gaseous fuels. These can be mixed already before entry into the atomizing apparatus according to the invention; however, it is also possible to supply water vapor and gaseous fuels to the gas flow 11 inside the atomizing apparatus, for example between the branch points 14, 16, or only after departure from the atomizing apparatus. The arrows A in FIG. 1 indicate these possibilities.

Water and fluid fuels such as gasoline, diesel, methanol, methanol/water mixtures, or gasoline/water emulsions are supplied to the atomizing apparatus as fluid educts. The fluid educts can be supplied to the partial gas flow 21 individually or mixed. Alternatively, a separate outlet point 26 can be provided for each fluid educt.

FIG. 2 shows a second exemplary embodiment of the atomizing apparatus according to the invention. Two separate gas supply lines 10, 10′ are provided, which make it possible to separately supply the atomizing apparatus according to the invention with the gaseous educts such as air, water vapor, and if need be, pre-atomized fuel. The gas supply line 10′ has an additional first branch point 14′ at which an additional partial gas flow 21′ splits off into an additional side line 20′. The additional side line 20′ feeds into the premixing chamber 22 like the side line 20.

In the flow direction of the gas flow 11′ after the branch point 14′, the additional gas supply line 10′ contains an additional throttle valve 18′ as an additional means for regulating the gas volume flow. The additional gas supply line 10′ feeds into the gas supply line 10, for example, between the throttle valve 18 and the vicinity of the cross sectional reduction 12. However, it is also possible to unite the gas supply lines 10, 10′ only after the atomizing apparatus in the flow direction of the gas flow 11, 11′. The arrows A′ in FIG. 2 indicate these possibilities.

All of the components of the atomizing apparatus are made, for example, of stainless steel, but other stable and corrosion-proof materials can also be used. In order to generate the hydrogen in the subsequent reformer, various educt mixtures can be used, depending on the requirements. Thus hydrogen can be obtained through partial oxidation of fuels through the alternative addition of water vapor, air, or a mixture of the two. The conversion usually takes place in a catalytic converter that can be heated and fuels such as gasoline, diesel, methane, or methanol can be used. Methanol/water mixtures or gasoline/water emulsions are also suitable in this regard.

Depending on the load requirements of the fuel cell, it is necessary to differentiate among different operating states of the reformer or the overall system. Even with changing operating states, the atomizing apparatus according to the invention is always able to supply the system with the required quantities and compositions of the necessary educts.

Under stationary operating conditions, the reformer must be supplied with air and/or water vapor. Air and water vapor can be supplied to the reformer either in a premixed form or as largely separate gas flows. For example, the fluid fuel is supplied to the atomizing apparatus at the outlet opening 26 via an atomizing nozzle and arrives in the partial flow 21, 21′ in a finely dispersed form, is mixed with the remainder gas flow 11a, and arrives in the reformer as a homogeneous gas/fluid mixture. Depending on the operating state of the reformer, the atomizing apparatus can also be used to supply water via the outlet point 26. This is important primarily when there are abrupt load alternations. It is also possible to supply the atomizing apparatus with fuel/water mixtures.

During the cold starting phase of the system, there is no water vapor available and the water is supplied to the reformer in fluid form. The high degree of atomization of the gas/fluid mixture generated by the atomizing apparatus according to the invention produces a considerable acceleration of the starting process. In addition, the starting behavior can be further improved by means of a heated catalytic converter in the reformer.

If the atomizing apparatus according to the invention is coupled to a corresponding metering system for the gaseous and fluid educts, then this results in an advantageous spatial separation of the metering and atomization. This is significant primarily if the atomizing apparatus is integrated into the reactor wall of the reformer since if metering valves, for example, were close to the reformer in terms of spatial distance, they would require cooling, which would be costly.

The atomizing apparatus according to the invention is not limited to the exemplary embodiments described; other embodiments of an atomizing apparatus are conceivable, which are based on a gas flow-supported atomization.

1. An atomizing apparatus for a gas/fluid mixture, in particular for introduction into a chemical reformer for generating hydrogen, with at least one gas supply line for supplying a gas flow and at least one fluid supply line for supplying a fluid flow, where the gas supply line (10, 10′) has at least one first branch point (14, 14′) at which a partial flow (21, 21′) of the gas flow (11, 11′) can be split off into a side line (20, 20′), which is embodied as a bypass and into which the fluid flow feeds at an outlet point (26) of the fluid supply line, where the gas supply line (10, 10′) has at least one second branch point (16) at which the side line (20) with the partial flow (21, 21′) containing the fluid flow can be reintroduced into the gas supply line (10), and where the side line (20, 20′) has a premixing chamber (22), which contains the outlet point (26), characterized in that the premixing chamber (22) contains a means for swirling the partial flow (21, 21′).

2. The atomizing apparatus according to claim 1, characterized in that the premixing chamber (22) can be heated.

3. The atomizing apparatus according to at least one of claims 1 to 2, characterized in that the gas supply line (10) has a region with a reduced cross section (12) in the vicinity of the second branch point (16).

4. The atomizing apparatus according to at least one of claims 1 to 3, characterized in that the gas supply line (10) is embodied as a venturi tube in the vicinity of the second branch point (16) and the second branch point (16) is disposed in the vicinity of the smallest cross section of the gas supply line (10).

5. The atomizing apparatus according to at least one of claims 1 to 4, characterized in that the outlet point (26) is embodied as an atomizing nozzle.

6. The atomizing apparatus according to at least one of claims 1 to 5, characterized in that water and/or a fuel can be supplied as fluids.

7. The atomizing apparatus according to at least one of claims 1 to 6, characterized in that the premixing chamber (22) has an annular conduit as a means for swirling the partial flow (21, 21′).

8. The atomizing apparatus according to at least one of claims 1 to 7, characterized in that the premixing chamber (22) is embodied cylindrically and, in order to prevent non-homogeneities, the partial flow (21, 21′) can be introduced tangentially into the premixing chamber (22).

9. The atomizing apparatus according to at least one of claims 1 to 8, characterized in that a means for regulating the gas volume flow, preferably a throttle valve (18), is provided in the gas supply line (10, 10′) in the flow direction of the gas flow (11, 11′) between the first branch point (14, 14′) and the second branch point (16).

10. The atomizing apparatus according to at least one of claims 1 to 9, characterized in that at least one second gas supply line (10′) is provided, from which an additional partial flow (21′) splits off at an additional branch point (14′) into an additional side line (20′), which is conveyed to the premixing chamber (22).

11. A use of an atomizing apparatus according to at least one of claims 1 to 10 for atomizing fluid educts of a reformer for fuel cells.
